(19) United States
(12) Patent Application Publication
(10) Pub. No.: US 2014/0138196 A1
(43) Pub. Date: May 22, 2014

(54) SHOCK-ABSORBING DEVICE

(71) Applicant: Alessandro MAZZUCCHELLI, SALE MARASINO (Brescia) (IT)

(72) Inventor: Alessandro MAZZUCCHELLI, SALE MARASINO (Brescia) (IT)

(73) Assignee: ADVANCE KITES S.R.L., SALE MARASINO (Brescia) (IT)

(21) Appl. No.: 14/074,761

(22) Filed: Nov. 8, 2013

(30) Foreign Application Priority Data
Nov. 8, 2012 (IT) MI2012A001904

(51) Int. Cl. F16F 7/01; F16F 9/34

(52) U.S. Cl. CPC F16F 7/01; F16F 9/34
USPC 188/268

(57) ABSTRACT

Provided is a passive protection device including a housing volume which is impermeable to air; at least one inner chamber which is permeable to air and housed in the housing volume, filling particles made of a vegetable fabric and housed in the inner chamber; at least one valve configured to make a fluid-passage connection between the inner chamber and the external environment so as to alter the extension of the inner chamber and to define an extended configuration, in which the distinct particles are freely movable inside the inner chamber, and a compressed configuration in which the distinct particles are compacted to form a solid body.

The present invention relates to a shock-absorbing device of the type as recited in the preamble of claim 1.

In particular, the present invention concerns a shock-absorbing device suitable for use with an object or by a person to cushion and protect the object or the person from excessive and localized forces such as those caused by collisions or impacts.

As is known, there are various types of devices for cushioning impacts.

Such devices generally comprise a rigid and resistant shell and a portion in deformable material suitable to be placed in contact with the object to be protected.

The rigid portions are, for example, made of metal or compound materials, while the deformable portions are generally made of elastomers, honeycomb polymers, cushions filled with various kinds of materials and so on.

Such devices are used in a large number of applications, such as: helmets, protective jackets, containers for fragile objects, various forms of protection for practising dangerous sports, stretchers and wheelchairs for the injured or disabled, rigid devices worn following an injury, and so on.

Moreover, in recent years this same applicant has designed specific shock-absorbing devices comprising a plurality of polymer spheres arranged inside a flexible container. Said spheres may be compacted or released by depressurizing or repressurizing the container.

Said devices are compacted around the part to be protected and consequently adapt their shape to that of said part, so as to permit an ideal and uniform distribution of the loads, caused by impacts, on the object they are protecting.

Despite the considerable improvements brought about by these shock-absorbing devices, which are particularly ideal for contrasting forces that are highly localized but not very strong, they still have some important drawbacks.

In particular, said devices are unable to adequately cushion particularly strong forces and impacts.

Moreover, said devices need to be more reliable so that they can be used for a long period of time in which the inner volumes undergo frequent depressurization and repressurization.

Lastly, in some cases the spheres in said devices tend to pile up in certain parts of the device as a consequence of gravitational forces.

In this situation the technical purpose of the present invention is to devise a shock-absorbing device able to substantially overcome the drawbacks mentioned above.

Within the scope of said technical purpose an important aim of the invention is to obtain a shock-absorbing device which is capable of guaranteeing good shock absorption at all times, even against strong impacts.

Another important aim of the invention is to obtain a shock-absorbing device that is particularly reliable and long-lasting.

The technical purpose and specified aims are achieved with a shock-absorbing device as claimed in the appended Claim 1.

Preferred embodiments are described in the dependent claims.

The characteristics and advantages of the invention are clearly evident from the following detailed description of preferred embodiments thereof, with reference to the accompanying drawings, in which:

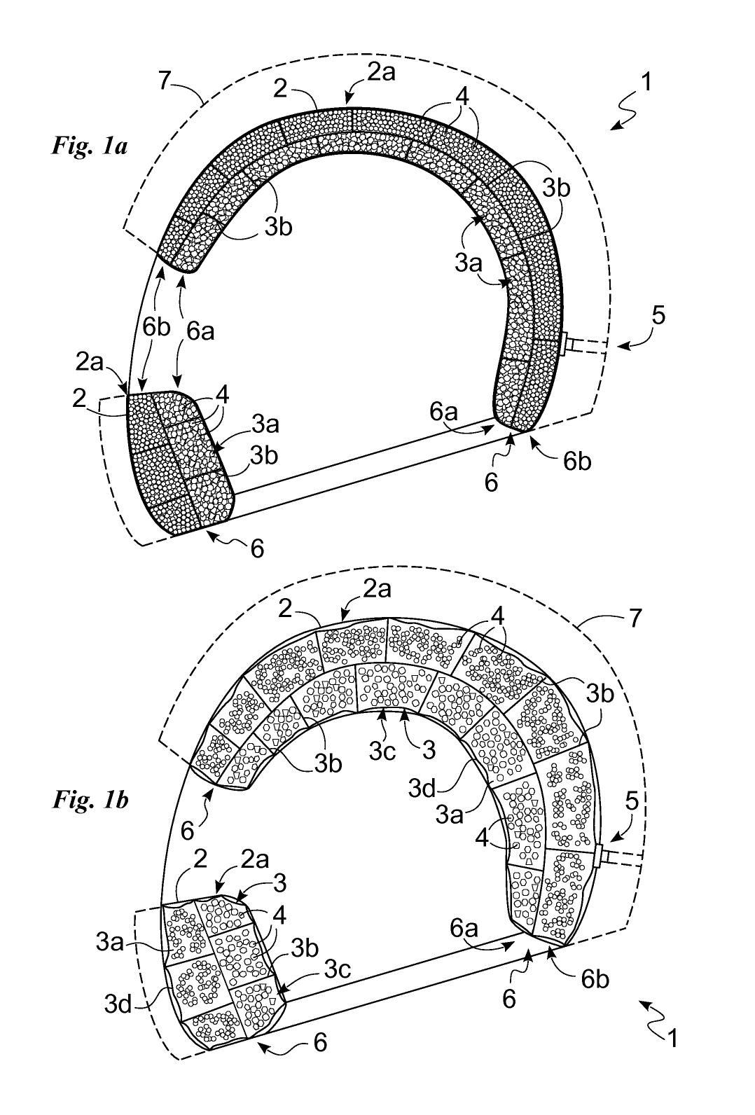

FIG. 1a shows a cross-sectional view of a shock-absorbing device according to the invention in a first configuration;

FIG. 1b shows the device of FIG. 1a in a second configuration;

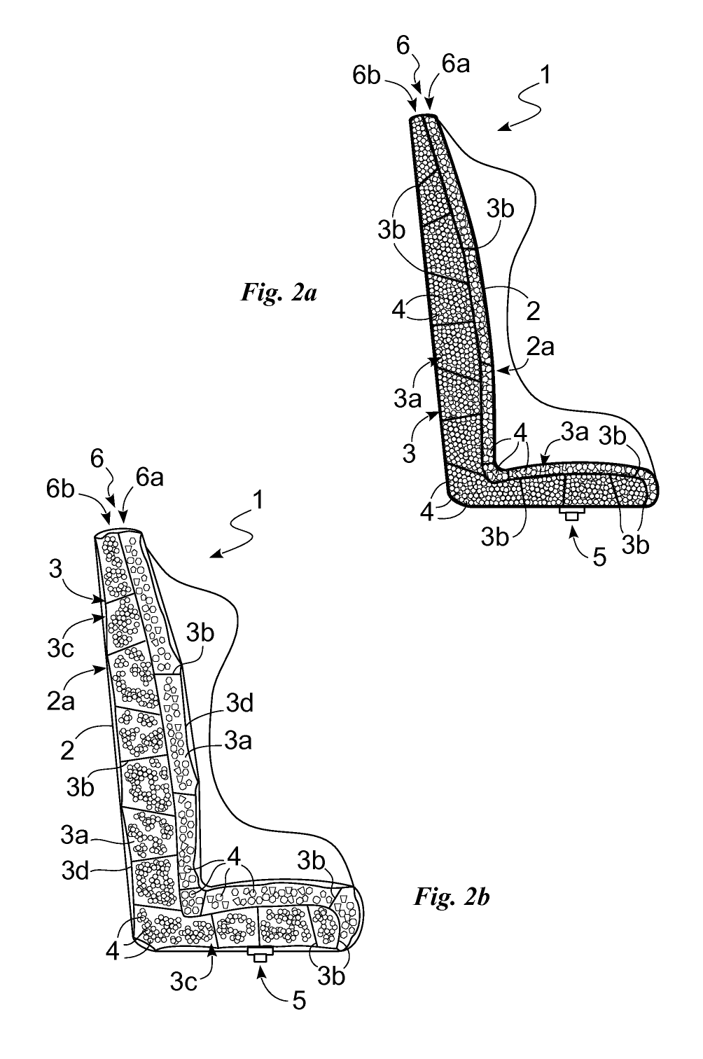

FIG. 2a shows a cross-sectional view of a different shock-absorbing device according to the invention in a first configuration;

FIG. 2b shows the device of FIG. 1a in a different second configuration;

FIG. 3 shows a seat with a shock-absorbing device according to the invention; and

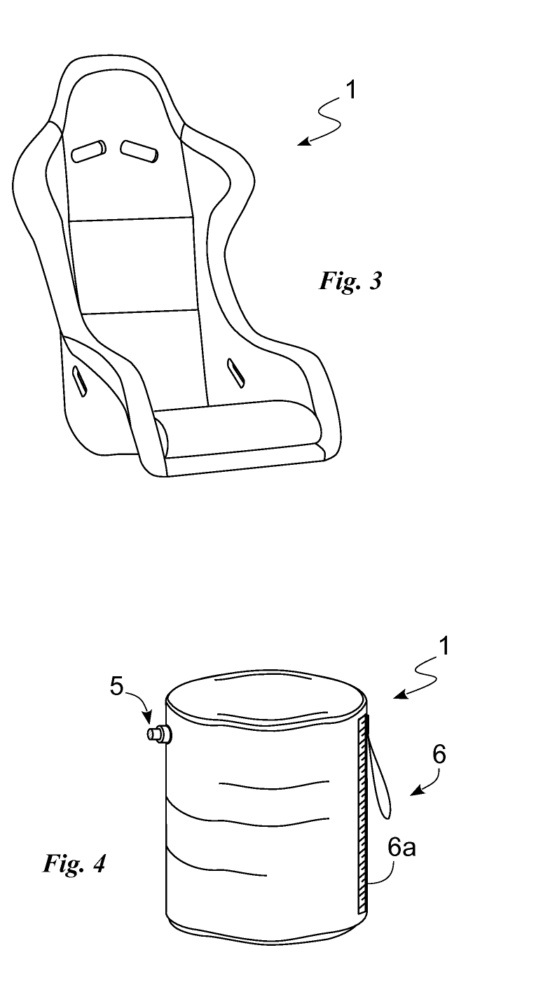

FIG. 4 shows a container comprising a shock-absorbing device according to the invention.

With reference to said drawings, reference numeral 1 globally denotes the shock-absorbing device according to the invention.

It is suitable to protect or support an object 10 against impacts and collisions, even strong impacts and collisions, by cushioning said impact and distributing it over a larger impact surface.

The term object 10 is used to refer to an element or a set or plurality of elements, or even a portion of an element, a person or an animal or even a part thereof. The shock-absorbing device 1 can be used for example: to contain and protect a fragile object, to protect a limb or the body of a person for safety reasons, to support the weight of a person riding on a saddle or a similar device, to create customized ergonomic elements, for all the uses cited previously and others as well.

The shock-absorbing device 1 comprises, in brief, a flexible outer container 2, impermeable to air and defining a primary volume 2a; a plurality of inner containers 3 permeable to air, housed in the outer container 2 and defining a plurality of secondary volumes 3a which are thus inside the primary volume 3a, a plurality of filling particles 4 housed in the inner volumes 3a. The outer container 2 also comprises at least one valve 5 suitable to make or interrupt an air-passage connection between the primary volume 2a and the external environment so as to permit the depressurization of the primary volume 2a, and the consequent depressurization of the secondary volumes 3a, so as to define a released configuration, in which the filling particles 4 are freely movable inside the inner containers 3a and a compressed configuration in which the particles 4 are compacted and form a rigid unit.

More in detail, the outer container 2 is made of a flexible membrane, preferably polymeric, which is also elastic, so as to allow the device 1 to better adapt to the shape of the object 10. In detail, it is preferably made of closed-cell EVA foam, polychloroprene or Neoprene®, polyvinyl chloride or compound materials.

The outer container 2 may also comprise an aperture 5a through which the object 10 can be inserted into said container. Said aperture 10 is also provided with closing means 5b impermeable to air, such as, for instance: special zip fasteners of the type used on diving suits, Velcro or other closing means.

The inner containers 3 are permeable to air, and are preferably made of materials which are permeable owing to their intrinsic and microscopic properties, such as, in particular fabric.

The containers 3 are also preferably elastic, in particular made of elastic fabric such as Lycra or a similar material.

In particular, there are a plurality of inner containers 3 reciprocally divided by walls 3b, which are also made of the same material as the inner containers 3, more specifically of fabric. The presence of walls 3a, as described more fully later on in this document, enables the principal volume 2a to be divided into a plurality of secondary volumes 3a of the desired height and dimensions in any area of said secondary volumes 3a. Said secondary volumes 3a permit a desired and determined arrangement of the filling particles 4.

Moreover, the secondary volumes 3a, as illustrated in the accompanying drawings, may be arranged side by side so as to obtain a cushioning layer 6 made up of inner containers 3 all arranged side by side. In detail, a cushioning layer 6 consists of a single casing divided by a plurality of walls 3b which together are suitable to form the different inner containers 3.

There may also be a plurality of superimposed layers 6, as described more fully below.

The filling particles 4 are movable inside the secondary volumes 3a. In particular, each volume comprises a plurality of particles 4.

The particles 4 may vary in shape, material and dimensions and be of different types so as to define a particular physical property of the compacted particles in the compressed configuration.

In particular one type of particles may be characterized by particles 4 made of a same material and, for example, with dimensions and shapes which may even vary from particle to particle.

Another type of particles 4 may be characterized by particles 4 which are all of the same shape and dimensions and possibly also made of partially different materials but which have similar mechanical properties.

Yet another type may consist of particles 4 which are very similar all having certain dimensions, shapes and materials, with the differences among them falling within very narrow tolerance margins.

In detail, the applicant has found that, surprisingly, with filling particles 4 made of cork it is possible to obtain a perfectly shock-absorbent layer which is also suitable to completely recover the elastic deformation sustained, even after repeated use.

Other important materials which can be very advantageously used with the present device are: cherry stones, and certain polymers such as: PPE (polyphenyl ethers), rubber or thermoplastic polymers, EPS (expanded polystyrene), TPU (thermoplastic polyurethane) and more in particular E-TPU (engineering thermoplastic polyurethane).

The particles may be of the following types: rigid polymers, elastomers, natural kernels and seeds, such as cherry stones, expanded polymers, metals or other rigid particles 4 and so on. Softer materials will constitute softer and more cushioning layers in the compressed configuration, while more rigid materials will constitute more rigid and resistant layers.

The types of particles may also have certain dimensions and shapes, though they are generally approximately spherical with a diameter of less than one millimetre. In particular, smaller-sized particles 4 constitute softer and more cushioning layers in the compressed configuration, while larger-sized particles 4 constitute more rigid and resistant layers.

In particular, each secondary volume 3a comprises filling particles 4 of the same type and different secondary volumes 3a may contain different types of filling particles 4.

Moreover, the layers 6 may appropriately comprise secondary volumes 3a all containing the same type of particles, superimposed on layers 6 comprising secondary volumes 3a all containing a same type of particles which differs from the type of the particles of the underlying layer 6.

For example, it is advantageous to provide a cushioning layer 6a comprising particles which are soft and cushioning, such as in particular particles made of cork, which is placed in contact with or close to the object 10, superimposed on a resistant layer 6b of resistant and rigid particles.

Said combination advantageously results in a rigid and cushioning shock-absorbing device 1 that is thus suitable to protect against even strong impacts or to provide a rigid support which also feels very comfortable.

Additional layers 6 may be also be provided and even outer layers 7 in conventional rigid or cushioning materials, such as conventional deformable polymers or rigid shells made of metal, high-modulus polymers or compound materials. Said outer layers 7 may constitute the outer container 2, or be an integral part thereof of simply connected thereto.

Lastly, the valve 5 is preferably a one-way air vent valve, similar to those used on inner tubes but which function in the opposite direction.

The functioning of a shock-absorbing device described above in a structural sense, is as follows.

To start with the device 1 is in the released configuration (FIGS. 1a and 2a), the volumes 2a and 3a are at ambient pressure and the device 1 is thus flexible and malleable, as the filling particles 4 are freely movable inside the secondary volumes 3a.

The device 1 is arranged in the correct position around the object 10 and adapted to said object 10. In particular the cushioning layers 6a are placed in contact with the object and the resistant layers 6b at a distance.

If the device 1 is provided with the aperture 5a, the object 10 is inserted and wrapped in one or more layers 6. The aperture is then closed again by means of the closing means 5b.

Next, using the valve 5 and a vacuum pump, preferably a manually-operated pump, the air is extracted from the principal volume 2a. The secondary volumes 3a, which are permeable to air, create an air-passage connection with the primary volume 2a, and are thus also depressurized.

The device 1 is thus in the compressed configuration and the particles 4 are compacted to create homogenous bodies with the dimensions of the layers 6 or of the secondary volumes 3a.

Said homogeneous bodies formed by the particles 4 adapt perfectly to the object 10, since they are shaped on the latter.

The resulting layers 6 thus have the properties of the type of particles 4 of which they are made up.

Moreover, the layers 6 are homogeneous with all three dimensions as desired, owing to the presence of the walls 3b which divide each inner container 3 and maintain the desired height.

The elasticity of the containers 2 and 3 also prevents any creasing or curling thereof, and keeps the surface smooth in both configurations.

In many cases, such as with containers, the device 1 is returned to the released configuration after use.

The invention achieves some important advantages.

The presence of different secondary volumes 3a, or entire layers 6, containing different types of filling particles 4 achieves, for example, a device 1 which is perfectly adapted to the object 10 and is both shock absorbent and resistant.

A further advantage is given by the presence of cork, which gives the device 1 an excellent cushioning structure.

Moreover, owing to its intrinsic properties, cork can be expanded and compressed for a substantially unlimited number of times, without altering its elasticity.

Polymers do not offer this advantage.

Cork also has a reduced environmental impact.

Similar advantages are achieved with cherry stones.

Modifications and variations may be made to the invention described herein without departing from the scope of the inventive concept. All the elements as described and claimed herein may be replaced with equivalent elements and the scope of the invention includes all other details, materials, shapes and dimensions.

1. A shock-absorbing device, comprising:
an outer container which is flexible and impermeable to air, defining a primary volume; a plurality of inner containers which are permeable to air, housed in said outer container and defining a plurality of secondary volumes defining portions of said primary volume;
a plurality of filling particles housed in said inner containers;
at least one valve arranged on said outer container and configured to make or interrupt an air-passage connection between said primary volume and the external environment and configured to permit the depressurization of said primary volume, so as to define a released configuration, in which said filling particles are movable inside the inner containers, and a compressed configuration in which said primary volume is depressurized and said distinct particles are compacted, and
wherein each of said inner containers comprises said filling particles that are the same and wherein at least two different inner containers are provided with different filling particles.

2. The shock-absorbing device as claimed in claim 1, wherein one of said types of filling particles is characterized by the presence of filling particles made of a selected material and wherein different types of filling particles are characterized by different types of material.

3. The shock-absorbing device as claimed in claim 2, wherein one of said types of filling particles is characterized by the presence of filling particles having selected dimensions and wherein different types of filling particles are characterized by different selected dimensions.

4. The shock-absorbing device as claimed in claim 2, wherein one of said types of filling particles is characterized by particles made of cork.

5. The shock-absorbing device as claimed in claim 2, wherein one of said types of filling particles is characterized by particles made of E-TPU.

6. The shock-absorbing device as claimed in claim 1, wherein said inner containers are made of fabric which is permeable to air.

7. The shock-absorbing device as claimed in claim 1, wherein said inner containers are reciprocally divided by walls.

8. The shock-absorbing device as claimed in claim 7, comprising at least one cushioning layer made up of a plurality of said inner containers arranged side by side.

9. The shock-absorbing device as claimed in claim 8, comprising at least one cushioning layer comprising a type of soft and cushioning filling particles and suitable to be placed close to said object, superimposed on a resistant layer comprising a type of resistant and rigid filling particles.

10. The shock-absorbing device as claimed in claim 9, wherein said cushioning layer comprises filling particles made of cork.
